(19) United States
(12) Patent Application Publication
(10) Pub. No.: US 2004/0117437 A1
(43) Pub. Date: Jun. 17, 2004

(54) Method for efficient storing of sparse files in a distributed cache

(75) Inventor: Shahar Frank, Ramat Hasharon (IL)

Correspondence Address: SUGHRUE MION, PLLC, 2100 PENNSYLVANIA AVENUE, N.W., SUITE 800, WASHINGTON, DC, 20037, US

(73) Assignee: EXANET, CO.

(21) Appl. No.: 10/319,494

(22) Filed: Dec. 16, 2002

(51) Int. Cl. G06F 15/16

(52) U.S. Cl. 709/203

(57) ABSTRACT

A method for performing efficient caching of sparse files in a distributed cache by use of an enumeration process is provided. According to the disclosed invention, the storage's objects are cached in the order that these objects are kept in the storage's directory. As a result, the directory content is enumerated in the cache, resulting in the cache not having to be associated with the server layout.

### BACKGROUND OF THE PRESENT INVENTION

1. Technical Field of the Invention

The present invention relates generally to the field of cache memory, and more, specifically to data caching in distributed file systems further capable of using distributed caches.

2. Description of the Related Art

Computer workstations have increased in power and storage capacity. A single operator used a workstation to perform one or more isolated tasks. The increased deployment of workstations to many users in an organization has created a need to communicate between workstations and share data between users. This has led to the development of distributed file system architectures.

A typical distributed file system comprises a plurality of clients and servers interconnected by a local area network (LAN) or wide area network (WAN). The sharing of files across such networks has evolved over time. The simplest form of sharing data allows a client to request files from a remote server. Data is then sent to the client and any changes or modifications to the data are returned to the server. Appropriate locks are created so that any given client does not change the data in a file that is already being manipulated by another client.

Distributed file systems improve the efficiency of processing of distributed files by creating a file cache at each client location that accesses server data. This cache is referenced by client applications and only a cache miss causes data to be fetched from the server. Caching of data reduces network traffic and speeds response time at the client. However, since multiple caches might exist in the system, it is imperative to ensure that cache coherency is maintained. The cached data must be updated when the data stored on the server is changed by another node in the network after the data was loaded into the cache.

In order to decrease the latency for information access, some implementations use distributed caches. Distributed caches appear to provide an opportunity to further combat latency by allowing users to benefit from data fetched by other users. The distributed architectures allow clients to access information found in a common place. Distributed caches define a hierarchy of data caches in which data access proceeds as follows: a client sends a request to a cache, and if the cache contains the data requested by a client, the data is made available to the requesting client. Otherwise, the cache may request its neighbors for the data, but if none of the neighbors serve the request, then the cache sends the request to its parent. This process recursively continues through the hierarchy until data is fetched from a server. One example of such a distributed cache is shown by Nir Peleg in PCT patent application number US01/19567, entitled “Scalable Distributed Hierarchical Cache”, which is assigned to common assignee and which is hereby incorporated by reference for all that it discloses.

Caches hold files in the same way that they are saved in the servers; thus, caches must have the same file layout as servers. Typically, servers arrange the files in blocks, and therefore, the cache's files are also arranged in blocks. In order to save a file in the cache, there is a need to save the entire block. This is a waste of cache resources. Additionally, traditional caches will store sparse files in the same input/output (I/O) pattern they were written into the disk. For example, a typical sparse file may be written using the following I/O operations: write 1 byte; skip 8 kilobytes; write 31 bytes. The sparse file includes two data chunks of 1 byte and 31 bytes, as well as a space block of 8 kilobytes. Traditional caches would save the entire file (i.e., 8 kilobytes +32 bytes), instead of only the data chunks that include the valuable data (i.e., 32 bytes). Clearly, applying such an approach on sparse files causes a significant waste of cache resources. Sparse files may be, but are not limited to, snapshot files and database files.

Therefore, it would be advantageous to have a method that efficiently caches sparse files. It would be further advantageous if the caching method enabled the use of caches that are not associated with the server layout.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the present invention provides a method for caching sparse files in a distributed storage system, with a distributed storage system comprising a client terminal and a storage node with a storage means and a cache. The method comprises receiving location information for a requested file, searching the cache for the requested file, and if the requested file is not found in the cache, then the method fetches data chunks of the requested file from the storage means and updates the cache with the retrieved file. Alternatively, if the requested file is found in the cache, then the method checks if the data chunks comprising the data of the requested file in the cache are in sequence. If the data chunks are not in sequence, then the method fetches the missing data chunks from the storage means and updates the cache with the retrieved data chunks. Finally, the method returns the requested file to the client terminal. The method searches the cache for the requested file begins from the start address of the requested file. The checking to determine if the data chunks are in sequence comprises checking the status of the sequence means associated with each of the data chunks. The method further comprises updating the cache by saving the data chunk fetched from the storage means in the cache, and marking the sequence means associated with the data chunk as sequenced. Saving the data chunk comprises allocating memory in the cache to fit the size of the data chunk.

A second aspect of the present invention provides computer executable code for efficiently caching sparse files in a distributed storage system, with a distributed storage system comprising a client terminal and a storage node with a storage means and a cache. The computer executable code comprises a first portion of executable code that, when executed, receives location information for a requested file, and a second portion of executable code that, when executed, searches the cache for the requested file. The code further comprises a third portion of executable code that, when executed, fetches the data chunks of the requested file from the storage means and updates the cache with the retrieved file, if the requested file is not found in the cache. The code further comprises a fourth portion of executable code that, when executed, checks if the data chunks comprising the data of the requested file in the cache are in sequence. If the data chunks are not in sequence, then the fourth portion fetches the missing data chunks from the storage means and updates the cache with the retrieved data chunks, if the requested file is found in the cache. The code comprises a fifth portion of executable code that, when executed, returns the requested file to the client terminal. The second portion of executable code searches the cache starting from the start address of the requested file. The fourth portion of the fourth portion of executable code checks if the data chunks are in sequence by determining the status of the sequence means associated with each of the data chunks. The fourth portion of executable code updates the cache by saving the data chunk fetched from the storage means in the cache, and marking the sequence means associated with the data chunk as sequenced.

A third aspect of the present invention provides a computer system capable of caching efficiently sparse files. The computer system comprises a cache adapted for storing variable size data chunks and further adapted to hold data chunks in a linked sequence and a storage means capable of storing and retrieving the data chunks. The computer system being capable of being connected to at least one file requesting means via a network. In order to cache sparse files, the computer system is adapted to receive location information for a requested file and search the cache for the requested file. If the requested file is not found in the cache, then the computer system fetches data chunks of the requested file from the storage means and updates the cache with the retrieved file. If the requested file is found in the cache, then the computer system checks if the data chunks comprising the data of the requested file in the cache are in sequence. If the data chunks are not in sequence, then the computer system fetches the missing data chunks from the storage means and update the cache with the retrieved data chunks. The computer system is further adapted to return the requested file to the client terminal. The computer system searches the cache for the requested file begins from the start address of the requested file. The updating of the cache comprises saving the data chunk fetched from the storage means in the cache and marking the sequence means associated with the data chunk as sequenced.

A fourth aspect of the present invention provides a computer system adapted to caching sparse files, wherein the computer system comprises a processor, a cache memory as described above, a storage means as described above, and a memory comprising software instructions adapted to enable the computer system to perform predetermined operations. The predetermined operations comprise receiving location information for a requested file and searching the cache for the requested file. If the requested file is not found in the cache, then the predetermined operations fetch data chunks of the requested file from the storage means and updating the cache with the retrieved file. If the requested file is found in the cache, then the predetermined operations check if the data chunks comprising the data of the requested file in the cache are in sequence. If the data chunks are not in sequence, then the predetermined operations fetch the missing data chunks from the storage means and update the cache with the retrieved data chunks. Finally, the predetermined operations return the requested file to a client terminal. In addition, the predetermined operations check if the data chunks are in sequence by checking the status of a sequence means associated with each of the data chunks. The predetermined operations update the cache by saving the data chunk fetched from the storage means in the cache and marking a sequence means associated with the data chunk as sequenced. When saving the data chunk in the cache, the predetermined operations allocate memory in the cache to fit the size of the data chunk.

A fifth aspect of the present invention provides a computer program product for caching sparse files, wherein the computer program product comprises software instructions for enabling a computer to perform predetermined operations and a computer readable medium bearing the software instructions. The software instructions comprise receiving location information for a requested file and searching a cache for the requested file. If the requested file is not found in the cache, then the software instructions fetch data chunks of the requested file from a storage means and updating the cache with the retrieved file. If the requested file is found in the cache, then the software instructions check if the data chunks comprising the data of the requested file in the cache are in sequence. If the data chunks are not in sequence, then the software instructions fetch the missing data chunks from the storage means and update the cache with the retrieved data chunks. Finally, the software instructions return the requested file to a client terminal. In addition, the software instructions check if the data chunks are in sequence by checking the status of a sequence means associated with each of the data chunks. The software instructions update the cache by saving the data chunk fetched from the storage means in the cache and marking a sequence means associated with the data chunk as sequenced. When saving the data chunk in the cache, the software instructions allocate memory in the cache to fit the size of the data chunk.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 illustrates a typical distributed storage network;

FIG. 2 is an exemplary flowchart describing the caching method according to the present invention; and

FIGS. 3A-3E illustrate the application of the present invention to sparse files.

### DETAILED DESCRIPTION OF THE PRESENT INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

A detailed description of the aspects of the present invention will now be given referring to the accompanying drawings.

The present invention provides a method for performing efficient caching of sparse files, such that only valuable data is saved to the cache. The invention caches data in the order in which it is kept in storage. In other words, the cache maintains the data in sequence. Thus, the system can preserve the access pattern to the disk.

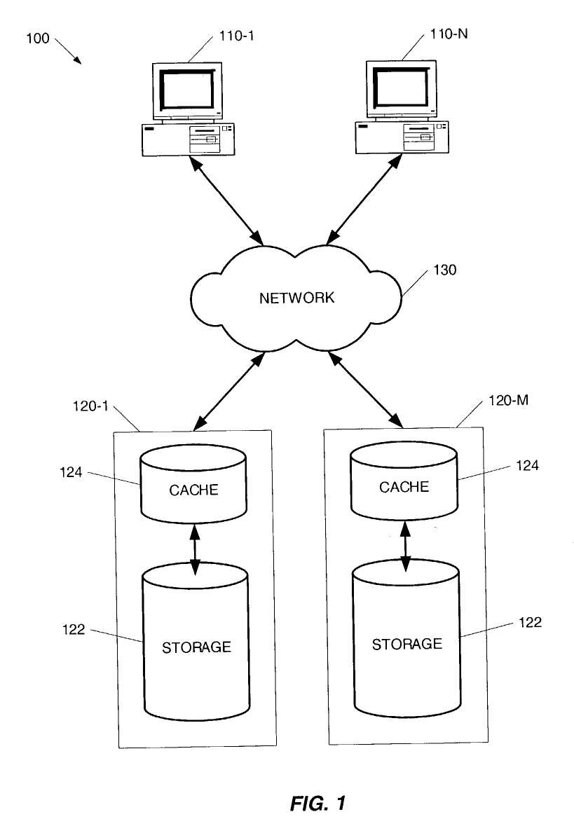

Referring to FIG. 1, a distributed file system 100 is illustrated. Distributed file system 100 comprises client terminals 110-1 to 110-n (n is the number of clients) and storage nodes 120-1 to 120-m (m is the number of storage nodes). Each storage node 120 comprises a storage medium 122 and a cache 124. Client terminals 110-1 to 110-n and storage nodes 120-1 to 120-m are connected through a standard network 130. The network 130 includes, but is not limited to, a local area network (LAN) or a wide area network (WAN). In each storage node 120, the cache 124 is a skip-list based cache. A detailed explanation of a skip list based cache is provided in U.S. patent application Ser. No. 10/122,183, entitled “An Apparatus and Method for a Skip-List Based Cache”, by Shahar Frank, which is assigned to common assignee and which is hereby incorporated by reference for all that it discloses. In a skip-list based cache, the data is kept according to a defined order, i.e., sorted according to a designated key. In traditional cache implementations, a key is used to access the data in cache 124. Storage medium 122 stores files and objects to be accessed by a client terminal 110 through the cache 124. The client terminal 110 instructs the storage medium 122 to send a file or a portion of it, using the “read” command. Typically, a “read” command includes at least the following parameters: (1) a file name, a start address and an end address of the file, or (2) a file name, a start address, and the number of bytes to return.

The caching method is performed whenever a client requests to read data from storage medium 122. To facilitate the caching of sparse files, the cache 124 receives from the client terminal 110 the start address of the requested file and the number of required bytes. The start address may be directed at any point of the requested file (e.g., the beginning of the file, a point in the middle of the file, etc.). Typically, a sparse file is a combination of several data chunks separated by blocks of spaces. The data chunks include the actual data that comprise the file. The cache 124 checks if the file resides in the memory of the cache 124. In addition, the cache 124 checks whether the data chunks that form the file are in sequence. Each data chunk is considered to be in sequence if it points to its neighbor's data chunks. A flag marks a data chunk that is part of a sequence. The sequence of data chunks in the cache 124 must be exactly as they are in the storage medium 122. If the file is found in the cache 124, and all the data chunks that are within the requested data range are in sequence, then the requested file is sent back to the client terminal 110.

If, on the other hand, the requested file does not reside in the cache 124, or part of the requested file is not found in the cache 124, or some of the data chunks are not in sequence, then the data is fetched from the storage medium 122. Specifically, only data chunks that form the file, i.e., data chunks containing valuable data, are obtained, while block spaces are dropped. For example, a file may be created using the following input/output (I/O) operations: (1) write 1 byte; (2) skip 8 kilobytes; (3) write 31 bytes. This file has the following attributes: a data chunk of a size of 1 byte, a space block of a size of 8 kilobytes, and another data chunk of a size of 31 bytes. Here, the disclosed caching method fetches only the data chunks, the links between them and marks them as synchronized. In the case where one of the data chunks in the cache 124 is not in sequence, then data is also fetched from the storage medium 122. However, only the missing data chunks are fetched from the storage medium 122. Subsequently, the cache 124 caches these data chunks in the right order, and marks them in sequence. It should be noted that this method can also be used for caching portions of files.

In addition, for each data chunk saved in the cache 124, the cache 124 allocates memory according to the data chunk's size. This reduces the use of cache resources. Moreover, this method enables preservation of the I/O access pattern by means of scanning the cache 124. It should be noted that a person skilled in the art could easily adapt this process to use other types of caches that enable the ability to maintain data in the order they appear in the storage. For example, any balanced tree based cache, or hash file based cache may serve this purpose.

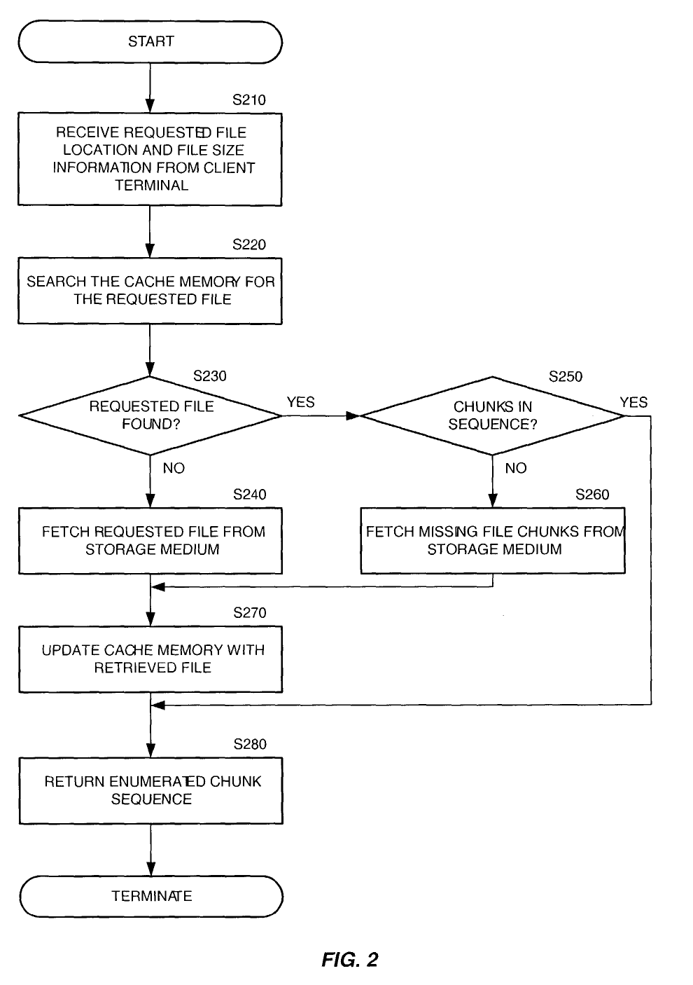

Referring to FIG. 2, an exemplary flowchart 200 for caching sparse files according to the present invention is shown. At S210, the cache 124 receives from the client terminal 110 the location information (i.e., start addresses) of the requested file or data section, and size information (i.e., number of bytes). It should be noted that the absence of a size field may be considered an indication for fetching the data from the entire file. Alternatively, the location information may include the start address and the end address of the desired file. In another embodiment only the file name is provided and a mapping means are used to map the file name to its specific location or locations in storage. At S220, the cache 124, by means of following through a skip list, searches for the requested file using the location information. If it is determined at S230 that the requested file does not reside in the memory of the cache 124, then execution continues at S240, otherwise the process continues at S250. At S240, since the requested data does not reside in the memory of the cache 124, the necessary data is fetched form another location and execution continues at S270. At S250, the cache 124 determines if the data chunks that form the file are in sequence, namely checking whether the sequence flag is raised. If all of the tested data chunks are in sequence, execution continues at S280. Otherwise, execution continues with S260 where the missing data is fetched from the storage medium 122. As a result of fetching the missing data, the requested data is now in sequence and execution can continue with S270. At S270, the data chunks retrieved from the storage medium 122 are saved into the cache 124 in sequence and flagged using the sequence flag. At S280, the cache 124 returns the requested data to client terminal 110.

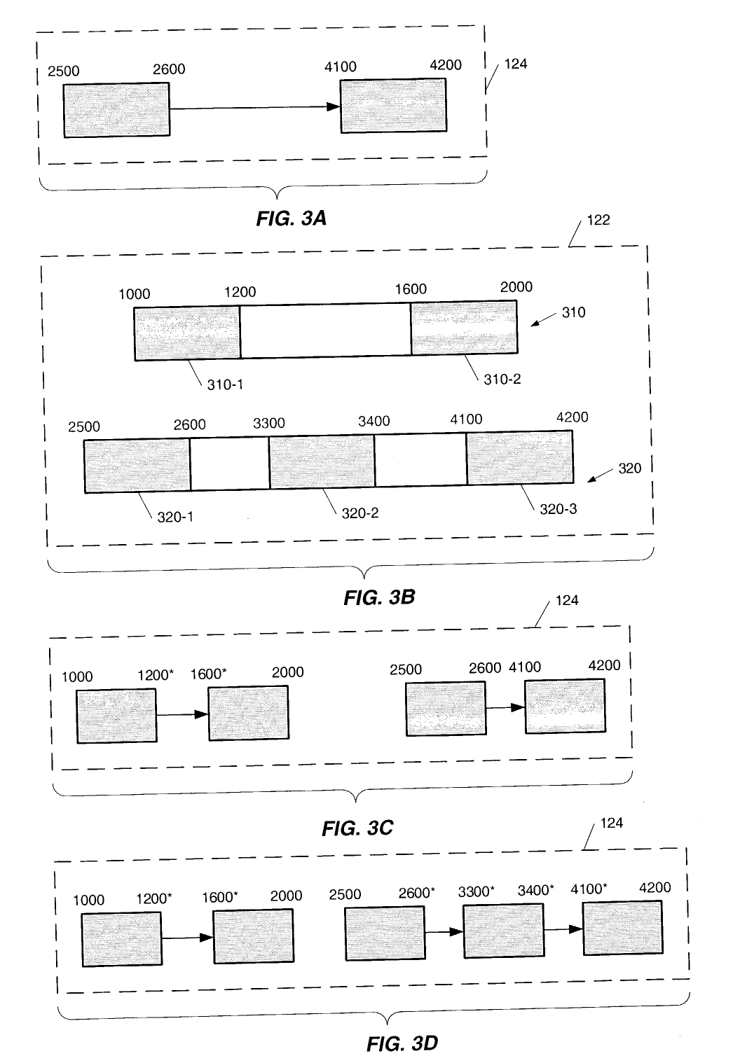

Referring to FIGS. 3A-3E, an example of a sparse file and its retrieval according to the present invention is illustrated. FIGS. 3A and 3B depict the content of the cache 124 and the storage medium 122, respectively. The storage medium 122 includes two files 310 and 320. The first file 310 starts at address “1000” and ends at address “2000” and includes two data chunks 310-1 and 310-2. The first data chunk 310-1 is located between the addresses “1000” and “1200”, and the second data chunk 310-2 is located between the addresses “1600” and “2000”. The second file 320 includes three data chunks 320-1 through 320-3. The data chunk 320-1 starts at address “2500” and ends at address “2600”, the second data chunk 320-2 starts at address “3300” and ends at address “3400”, and the third data chunk 320-3 starts at address “4100” and ends at address “4200”. The cache 124 includes only part of the second file 320. Using an asterisk (“*”) marks a data chunk that is in sequence, however, at this point the portion of the file 320 residing in the cache 124 are not synchronized as data chunk 320-2 is missing.

In one scenario, the client terminal 110 requests the file 310 from the cache 124, and the client terminal 110 provides the cache 124 with the location information of the file 310 (i.e., address “1000” through “2000”). The cache 124 searches for the file 310 in its memory. It should be noted thought that while in this example the location information is provided by the client terminal 110, that it is envisioned that other implementations, including the use of a mapping means, is within the scope of this invention. As can be seen in FIG. 3A, the file 310, in its entirety, does not reside in the memory of the cache 124. Therefore, the cache 124 initiates a fetch of the missing data from the storage medium 122. The cache 124 retrieves only the data chunks 310-1 and 310-2 and discards the space block found between addresses “1200” through “1600”) that is included in the file 310. In addition, the cache 124 links the data chunks 310-1 and 310-2 and marks them as “in sequence” using the sequence flag. The status of the cache 124 after caching the file 310 is shown in FIG. 3C. Therefore, the cache status is having to synchronized blocks of the file 310 and two unsynchronized files of file 320.

In another scenario, the client terminal 110 requests the file 320 from the cache 124. The client terminal 110 provides the cache 124 with the start address of the file 320 (i.e., “2500”) and the end address of the file 320 (i.e., “4200”). The cache 124 checks if the file is resident in its memory. As shown in FIG. 3A, the cache 124 will determine that only a part of the file 320, i.e., data chunks 320-1 and 320-3, are available and the cache 124 further determines that the data chunks are not marked as in sequence. The fact that the data chunks 320-1 and 320-3 are not in sequence indicates that at least one data chunk belonging to the file 320 is absent.

In order to fetch the missing data chunk(s) from the storage medium 122, the cache 124 provides the storage medium 122 with the end address of the first data chunk 320-1 (i.e., “2600”) and the start address of the third data chunk 320-3 (i.e. “4100”). Namely, the cache 124 requests from the storage medium 122 all the missing data between addresses “2600” and “4100”. The storage medium 122 responds by sending to the cache 124 the data chunk 320-2, because the other blocks are space blocks that are discarded. The data chunk 320-2 is linked to the data chunks 320-1 and 320-2, and then they are marked as “in sequence” using the sequence flag. The result of this process is shown in FIG. 3D. It can be noticed that using this method only 900 bytes were actually cached (600 bytes from file 310 and 300 bytes from file 320), as opposed to prior art approaches which save entire files (including blocks of spaces) in the cache, i.e., 2,700 bytes.

It should be noted that a person skilled in the art could easily preserve the I/O pattern access, by scanning cache 124. For instance, the I/O pattern access of the file 320 is: (1) write 100 bytes, (2) skip 700 bytes, (3) write 100 bytes, (4) skip 700 bytes, and (5) write 100 bytes. Alternatively, the I/O pattern access of the file 320 is: (1) read 100 bytes, (2) skip 700 bytes, (3) read 100, (4) skip 700 bytes, and (5) read 100 bytes.

In an another embodiment, the present invention provides a computer system capable of caching efficiently sparse files. The computer system comprises a cache adapted for storing variable size data chunks and further adapted to hold data chunks in a linked sequence and a storage means capable of storing and retrieving the data chunks. The computer system is capable of being connected to at least one file requesting means via a network.

In order to cache sparse files, the computer system is adapted to receive location information for a requested file and search the cache for the requested file. If the requested file is not found in the cache, then the computer system fetches data chunks of the requested file from the storage means and updates the cache with the retrieved file. If the requested file is found in the cache, then the computer system checks if the data chunks comprising the data of the requested file in the cache are in sequence. If the data chunks are not in sequence, then the computer system fetches the missing data chunks from the storage means and update the cache with the retrieved data chunks. The computer system is further adapted to return the requested file to the client terminal.

The computer system searches the cache for the requested file begins from the start address of the requested file. If the computer system has to update the cache because a portion (or portions) of a requested file were not stored in the cache, the data chunk fetched from the storage means is stored in the cache and the computer system marks the sequence means associated with the data chunk as sequenced data.

In another embodiment, the present invention provides computer executable code for efficiently caching sparse files in a distributed storage system, with a distributed storage system comprising a client terminal and a storage node with a storage means and a cache. The computer executable code comprises a first portion of executable code that, when executed, receives location information for a requested file, and a second portion of executable code that, when executed, searches the cache for the requested file. The code further comprises a third portion of executable code that, when executed, fetches the data chunks of the requested file from the storage means and updates the cache with the retrieved file, if the requested file is not found in the cache. The code further comprises a fourth portion of executable code that, when executed, checks if the data chunks comprising the data of the requested file in the cache are in sequence. If the data chunks are not in sequence, then fourth portion of the code fetches the missing data chunks from the storage means and updates the cache with the retrieved data chunks, if the requested file is found in the cache. The code comprises a fifth portion of executable code that, when executed, returns the requested file to the client terminal.

When a file is requested, the second portion of executable code searches the cache starting from the start address of the requested file. To determine if the data chunks are properly sequenced, the fourth portion of the fourth portion of executable code determines the status of the sequence means associated with each of the data chunks. In addition, the fourth portion of executable code updates the cache by saving the data chunk fetched from the storage means in the cache, and marking the sequence means associated with the data chunk as sequenced.

In another embodiment, the present invention provides a computer system adapted to caching sparse files, wherein the computer system comprises a processor, a cache memory as described above, a storage means as described above, and a memory comprising software instructions adapted to enable the computer system to perform predetermined operations. The predetermined operations comprise receiving location information for a requested file and searching the cache for the requested file. If the requested file is not found in the cache, then the predetermined operations fetch data chunks of the requested file from the storage means and updating the cache with the retrieved file. If the requested file is found in the cache, then the predetermined operations check if the data chunks comprising the data of the requested file in the cache are in sequence. If the data chunks are not in sequence, then the predetermined operations fetch the missing data chunks from the storage means and update the cache with the retrieved data chunks. Finally, the predetermined operations return the requested file to a client terminal.

In addition, the predetermined operations check if the data chunks are in sequence by checking the status of a sequence means associated with each of the data chunks. The predetermined operations update the cache by saving the data chunk fetched from the storage means in the cache and marking a sequence means associated with the data chunk as sequenced. When saving the data chunk in the cache, the predetermined operations allocate memory in the cache to fit the size of the data chunk. Also, the predetermined operations of this embodiment of the present invention incorporate all other the features of the present invention described earlier, and therefore, the description thereof is omitted.

Another embodiment of the present invention provides a computer program product for caching sparse files, wherein the computer program product comprises software instructions for enabling a computer to perform predetermined operations and a computer readable medium bearing the software instructions. The software instructions comprise receiving location information for a requested file and searching a cache for the requested file. If the requested file is not found in the cache, then the software instructions fetch data chunks of the requested file from a storage means and updating the cache with the retrieved file. If the requested file is found in the cache, then the software instructions check if the data chunks comprising the data of the requested file in the cache are in sequence. If the data chunks are not in sequence, then the software instructions fetch the missing data chunks from the storage means and update the cache with the retrieved data chunks. Finally, the software instructions return the requested file to a client terminal.

The software instructions borne on the computer readable medium check if the data chunks are in sequence by checking the status of a sequence means associated with each of the data chunks. The software instructions update the cache by saving the data chunk fetched from the storage means in the cache and marking a sequence means associated with the data chunk as sequenced. When saving the data chunk in the cache, the software instructions allocate memory in the cache to fit the size of the data chunk. In addition, the software instructions of this embodiment of the present invention incorporate all other the features of the present invention described earlier, and therefore, the description thereof is omitted.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to explain the to enable one skilled in the art to utilize the present invention in various embodiments and with various modifications as are suited to the particular use contemplated. Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terms used and they should not be construed to restrict the scope of the claims to the embodiments described therein.

1. A method for caching sparse files in a distributed storage system, the distributed storage system comprising at least one client terminal and at least one storage node, the storage node comprising at least a storage means and a cache, wherein the method comprises:
receiving location information for a requested file;
searching the cache for the requested file;
if the requested file is not found in the cache, then fetching data chunks of the requested file from the storage means and updating the cache with the retrieved file;
if the requested file is found in the cache, then checking if the data chunks comprising the data of the requested file in the cache are in sequence, and if the data chunks are not in sequence, then fetching the missing data chunks from the storage means and updating the cache with the retrieved data chunks; and
returning the requested file to the client terminal.

2. The sparse file caching method as claimed in claim 1, wherein said location information is received from at least one of a client terminal, a computer server and a mapping means.

3. The sparse file caching method as claimed in claim 1, wherein the storage node is at least one of a host, a server, a file server, a file-system, a location independent file system and a geographically distributed computer system.

4. The sparse file caching method as claimed in claim 1, wherein the cache is least one of a skip-list based cache, a balanced tree based cache and a hash file based cache.

5. The sparse file caching method as claimed in claim 1, wherein the sparse file comprises a plurality of data chunks and at least a single space block.

6. The sparse file caching method as claimed in claim 5, wherein the plurality of data chunks occupies significantly less space then the single space block.

7. The sparse file caching method as claimed in claim 1, wherein the data chunk comprises a portion of the sparse file that contains valuable data.

8. The sparse file caching method as claimed in claim 1, wherein said method further comprises data chunk sequence means.

9. The sparse file caching method as claimed in claim 8, wherein said sequence means are at least a sequence flag associated with said data chunk.

10. The sparse file caching method as claimed in claim 1, wherein the sparse file is at least one of a snapshot file and a database file.

11. The sparse file caching method as claimed in claim 1, wherein the location information comprises at least a start address of the requested file.

12. The sparse file caching method as claimed in claim 11, wherein the location information further comprises the byte size of the requested file.

13. The sparse file caching method as claimed in claim 11, wherein the search in the cache for the requested file begins from the start address of the requested file.

14. The sparse file caching method as claimed in claim 1, wherein the location information comprises at least a start address of the requested file and an end address of the requested file.

15. The sparse file caching method as claimed in claim 14, wherein the search in the cache for the requested file begins from the start address of the requested file.

16. The sparse file caching method as claimed in claim 1, wherein checking if the data chunks are in sequence comprises checking the status of the sequence means associated with each of the data chunks.

17. The sparse file caching method as claimed in claim 1, wherein updating the cache comprises:
saving the data chunk fetched from the storage means in the cache; and
marking the sequence means associated with the data chunk as sequenced.

18. The sparse file caching method as claimed in claim 17, wherein saving the data chunk comprises allocating memory in the cache to fit the size of the data chunk.

19. Computer executable code for efficiently caching sparse files in a distributed storage system, the distributed storage system comprising at least one client terminal and at least one storage node, the storage node comprising a storage means and a cache, the code comprising:
a first portion of executable code that, when executed, receives location information for a requested file;
a second portion of executable code that, when executed, searches the cache for the requested file;
a third portion of executable code that, when executed, fetches the data chunks of the requested file from the storage means and updates the cache with the retrieved file, if the requested file is not found in the cache;
a fourth portion of executable code that, when executed, checks if the data chunks comprising the data of the requested file in the cache are in sequence, and if the data chunks are not in sequence, then fetches the missing data chunks from the storage means and updates the cache with the retrieved data chunks, if the requested file is found in the cache; and
a fifth portion of executable code that, when executed, returns the requested file to the client terminal.

20. The computer executable code as claimed in claim 19, wherein said location information is received from one of: client terminal, a server, and mapping means.

21. The computer executable code as claimed in claim 19, wherein the storage node is at least one of a host, a server, a file server, a file-system, a location independent file system and a geographically distributed computer system.

22. The computer executable code as claimed in claim 19, wherein the cache is least one of a skip-list based cache, a balanced tree based cache and a hash file based cache.

23. The computer executable code as claimed in claim 19, wherein the sparse file comprises a plurality of data chunks and at least a single space block.

24. The computer executable code as claimed in claim 23, wherein the plurality of data chunks occupies significantly less space than the single space block.

25. The computer executable code as claimed in claim 19, wherein the data chunk comprises a portion of the file that contains a valuable data.

26. The computer executable code as claimed in claim 19, wherein sequence means are associated with each data chunk.

27. The computer executable code as claimed in claim 26, wherein said sequence means are at least a sequence flag.

28. The computer executable code as claimed in claim 19, wherein the sparse file is at least one of a snapshot file and a database file.

29. The computer executable code as claimed in claim 19, wherein the location information of the requested file comprises a start address of the requested file.

30. The computer executable code as claimed in claim 29, wherein the location information further comprises the byte size of the requested file.

31. The computer executable code as claimed in claim 24, wherein the second portion of executable code searches the cache starting from the start address of the requested file.

32. The computer executable code as claimed in claim 19, wherein the location information of the requested file comprises a start address of the requested file and an end address of the requested file.

33. The computer executable code as claimed in claim 31, wherein the second portion of executable code searches the cache starting from the start address of the requested file.

34. The computer executable code as claimed in claim 19, wherein the fourth portion of executable code checks if the data chunks are in sequence by determining the status of the sequence means associated with each of the data chunks.

35. The computer executable code as claimed in claim 19, wherein the fourth portion of executable code updates the cache by:
saving the data chunk fetched from the storage means in the cache; and
marking the sequence means associated with the data chunk as sequenced.

36. The computer executable code as claimed in claim 35, wherein saving the data chunk comprises allocating memory in the cache to fit the size of the data chunk.

37. A computer system capable of caching efficiently sparse files, the computer system comprising:
a cache adapted for storing variable size data chunks and further adapted to hold data chunks in a linked sequence;
a storage means capable of storing and retrieving the data chunks; and
the computer system being capable of being connected to at least one file requesting means via a network.

38. The computer system as claimed in claim 37, wherein said file requesting means are at least one of a client terminal, a server and mapping means.

39. The computer system as claimed in claim 37, wherein the network is at least one of a local area network, a wide area network and a geographically distrusted network.

40. The computer system as claimed in claim 37, wherein the computer system is at least one of a host, a file server, a file system and a location independent file system.

41. The computer system as claimed in claim 40, wherein the computer system is at least part of a geographically distributed computer system.

42. The computer system as claimed in claim 37, wherein the cache is least one of a skip-list based cache, a balanced tree based cache and a hash file based cache.

43. The computer system as claimed in claim 37, wherein, in order to cache sparse files, the computer system is adapted to:
receive location information for a requested file;
search the cache for the requested file;
if the requested file is not found in the cache, then fetch data chunks of the requested file from the storage means and update the cache with the retrieved file;
if the requested file is found in the cache, then check if the data chunks comprising the data of the requested file in the cache are in sequence, and if the data chunks are not in sequence, then fetch the missing data chunks from the storage means and update the cache with the retrieved data chunks; and
return the requested file to the client terminal.

44. The computer system as claimed in claim 43, wherein said location information is received from one of: client terminal, computer server, mapping means.

45. The computer system as claimed in claim 43, wherein the sparse file comprises a plurality of data chunks and at least a single space block.

46. The computer system as claimed in claim 45, wherein the plurality of data chunks occupies significantly less space than the at least a single space block.

47. The computer system as claimed in claim 43, wherein the data chunk comprises a portion of the file that contains valuable data.

48. The computer system as claimed in claim 43, wherein the data chunk is further associated with sequence means.

49. The computer system as claimed in claim 48, wherein said sequence means are at least a sequence flag.

50. The computer system as claimed in claim 43, wherein the sparse file is at least one of a snapshot file and a database file.

51. The computer system as claimed in claim 43, wherein the location information of the requested file comprises a start address of the requested file.

52. The computer system as claimed in claim 51, wherein the location information further comprises the byte size of the requested file.

53. The computer system as claimed in claim 51, wherein the searching the cache for the requested file begins from the start address of the requested file.

54. The computer system as claimed in claim 43, wherein the location information of the requested file comprises at least a start address of the requested file and an end address of the requested file.

55. The computer system as claimed in claim 54, wherein the searching the cache for the requested file begins from the start address of the requested file.

56. The computer system as claimed in claim 43, wherein updating the cache comprises:
saving the data chunk fetched from the storage means in the cache;
marking the sequence means associated with the data chunk as sequenced.

57. The computer system as claimed in claim 56, wherein saving the data chunk comprises allocating memory in the cache to fit the size of the item.

58. A computer system adapted to caching sparse files, the computer system comprising:
a processor;
a cache;
a storage means;
a memory comprising software instructions adapted to enable the computer system to:
receiving location information for a requested file;
searching the cache for the requested file;
if the requested file is not found in the cache, then fetching data chunks of the requested file from the storage means and updating the cache with the retrieved file;
if the requested file is found in the cache, then checking if the data chunks comprising the data of the requested file in the cache are in sequence, and if the data chunks are not in sequence, then fetching the missing data chunks from the storage means and updating the cache with the retrieved data chunks; and
returning the requested file to a client terminal.

59. The computer system as claimed in claim 58, wherein checking if the data chunks are in sequence comprises checking the status of a sequence means associated with each of the data chunks.

60. The computer system as claimed in claim 58, wherein updating the cache comprises:
saving the data chunk fetched from the storage means in the cache; and
marking a sequence means associated with the data chunk as sequenced.

61. The computer system as claimed in claim 60, wherein saving the data chunk comprises allocating memory in the cache to fit the size of the data chunk.

62. A computer program product for caching sparse files, the computer program product comprising:
software instructions for enabling a computer to perform predetermined operations, and a computer readable medium bearing the software instructions;
wherein the predetermined operations comprise:
receiving location information for a requested file;
searching the cache for the requested file;
if the requested file is not found in a cache, then fetching data chunks of the requested file from a storage means and updating the cache with the retrieved file;
if the requested file is found in the cache, then checking if the data chunks comprising the data of the requested file in the cache are in sequence, and if the data chunks are not in sequence, then fetching the missing data chunks from the storage means and updating the cache with the retrieved data chunks; and
returning the requested file to a client terminal.

63. The computer program product as claimed in claim 62, wherein checking if the data chunks are in sequence comprises checking the status of a sequence means associated with each of the data chunks.

64. The computer program product as claimed in claim 62, wherein updating the cache comprises:
saving the data chunk fetched from the storage means in the cache; and
marking a sequence means associated with the data chunk as sequenced.

65. The computer program product as claimed in claim 64, wherein saving the data chunk comprises allocating memory in the cache to fit the size of the data chunk.
